(19) United States
(12) Patent Application Publication
(10) Pub. No.: US 2011/0015972 A1
(43) Pub. Date: Jan. 20, 2011

(54) SYSTEM FOR MANAGING METERED VEHICLE PARKING

(75) Inventors: Pastora Valdecantos Pardo de Santayana, Madrid (ES); Pedro Valdecantos Pardo de Santayana, Madrid (ES); Jose Heredero Gracia, Madrid (ES)

Correspondence Address: HAVERSTOCK & OWENS LLP, 162 N WOLFE ROAD, SUNNYVALE, CA, 94086, US

(73) Assignee: VALHER GESTION DE APARCAMIENTOS, S.L., Madrid (ES)

(21) Appl. No.: 12/863,982

(22) PCT Filed: Jan. 23, 2008
(86) PCT No.: PCT/ES08/00032

§ 371 Date: Oct. 5, 2010

(51) Int. Cl. G07B 15/02; G06Q 50/00; G06Q 30/00; B60Q 1/48

(52) U.S. Cl. 705/13; 340/932.2

(57) ABSTRACT

Parking management system for automobile vehicles that uses two devices, a PJP and an MFL, which develop functions relating to traditional parking, or the controlled parking located in public thoroughfares. The PJP is a transmitter/receiver frontally equipped with three lights (green, yellow, red), which indicate the state of authorization of parking, and three lights (white, green, blue), which determine parking areas. At the rear part it will have an alphanumeric keyboard, a digital display and six keys (three for areas of controlled parking and three for the status of the payment for parking), and will be equipped with a card reader. The MFL will be a transmitter/receiver of waves, with a signal transponder, a computer, a printer, a coin box, a slot and a display for its possible manual use, and offers an auxiliary transmitter/receiver to send or receive telephonic messages relating to the service.

The object of the present invention relates to a system of automated and remote tele-payment management and control of public parking and regulated parking areas by using only two devices using remote communication.

### BACKGROUND OF THE INVENTION

Currently, the payment system for controlled motor vehicle parking in the authorized spaces on public roads, implies depositing a certain amount of cash in coins at ATMs located on such public roads and obtaining a receipt to be placed inside of the vehicles near the front windshield, so they are readable from the outside by the guards.

These receipts express, among other things, the time limit covered by the payment. This system has the disadvantage that many users do not have enough or the exact amount of coins to pay for the desired time, which is always limited to a maximum of two or at the most, three hours

The applicant is aware of the existence of similar inventions but in no case do they cover the subject matter of this invention, as is the case of patent ES2058681 referred to an automated portable control and payment device specially designed for public parking that is automatically activated with a specific personal parking card by pressing a start button on the device and including a separable means of time measurement and is synchronized with the parking time-meter but is not adapted to the remote communication covered under the present invention. Likewise, the patent PCT WO9949419 relates to automated control and vehicle parking payment through a communication network, which includes a parking unit installed in the vehicle, at least one tracking station to activate the parking unit and at least one central mobile station to communicate with tracking station and to receive communications from the vehicle user.

### DESCRIPTION OF THE INVENTION

Unlike what is known so far, the present invention for registration, proposes a new system based on the new technologies, the so-called VALHER system, whereby basically thanks to a PJP-type device (parking job program), installed inside the vehicle, either portable or fixed, payment of the service can be accessed and charged to a bank account or a payment card, whether credit, debit, prepaid or any other similar card.

The system works for both public and private parking as well as for places on public roads declared as controlled parking by means of two devices: the aforementioned PJP and a second called MFL (multifrecuency line) located outside the vehicle, whose operation combined with the other is as follows:

### a) In Public or Private Parking.—

The PJP device emits an input signal which is received by the MFL transmitter/receiver, after which it authorizes the PJP device, and therefore the motor vehicle in which it is installed, access to the parking, lifting the corresponding barrier. At this time, the MFL starts to check the code sent by the PJP requesting the authorization to use the parking lot. When the vehicle leaves the parking lot, the PJP issues another output signal to the MFL, and the latter authorizes the exit, raising an appropriate barrier, after which the corresponding code billing closes for statistical purposes and for the purpose of accordingly charging the account or card.

b. In Parking on Public Roads
We can distinguish two cases:

### Case Number 1

The driver of a motor vehicle equipped with a PJP device chooses a free parking place, he/she parks and selects on the PJP the type of area it is (white, green or blue).

Done this, he/she presses the PJP's Start button and a signal is sent to the nearest MFL to request parking permission. This MFL gives the requested authorization, and sends a signal that enables the PJP device lighting a green light on the front of this device, light meaning that the motor vehicle concerned is authorized to park, and that it is being billed according to the applicable fee.

When the driver of the vehicle decides to leave the parking space, he/she presses the end of presence button, and PJP emits a signal received by the MFL, and it authorizes the end of the billing and sends a signal to PJP for it to turn off the green light.

Likewise, the MFL saves the data for statistical purposes and the relevant payment data.

### Case Number 2,—

In the event that the driver of the vehicle equipped with a PJP exceeds the maximum time permitted in the area where he is parked, the MFL device will send a signal to the PJP, and this will change the green light for a yellow light, while it can send the driver an SMS message warning him/her of the situation. After a preset time of the yellow light being on, during which parking can be billed at an increased rate, the yellow light turns off and a red light comes on, which means that the vehicle is in a situation of unpaid parking and can therefore be reported. If in such a situation the relevant guard reports a complaint, the user of the PJP, through an alphanumeric keyboard may enter the corresponding fine code, sending a signal to the MFL, which will register the payment and cancel the fine.

### DESCRIPTION OF THE DRAWINGS

To complement the above description and in order to help a better understanding of the characteristics of the invention, a detailed description of a preferred embodiment is provided, based on a set of drawings accompanying this specification and where with a merely indicative nature without limitation, the following has been shown:

FIG. 1 shows a view in perspective of the PJP device seen from inside the vehicle,

FIG. 2 shows a view of the PJP device as seen from outside the vehicle.

FIG. 3 shows a bottom view of the PJP device.

FIG. 4 shows a diagram of the system whereby the PJP device emits a signal.

FIG. 5 shows a diagram of the system whereby the MFL device receives the signal from the PJP device.

FIG. 6. Shows a diagram of the system whereby the MEL device emits a signal.

In previous figures the numerical references correspond to the following parts and elements.
1—PJP Device
2—MFL Device
3—Authorization Lights
4—Zone lights
5—Alphanumeric Keyboard
6—Digital Display
7—Zone Keys
8—State keys
9—Payment card reader-slot
10—Barcode
11—Power outlet

### DESCRIPTION OF A PREFERRED EMBODIMENT

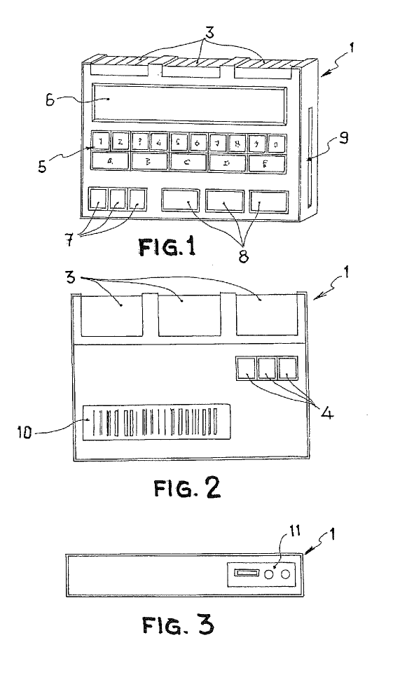

The fixed or portable PJP device (1) placed inside the vehicle, measuring approximately 10×10 cm, is a transmitter/receiver of any type of waves (preferably RF). This device is equipped on the side that is facing outwards from the vehicle (FIG. 2), with three large coloured lights (3) Green, yellow and red to identify the temporary state of authorized parking. In the same place, it also has three small coloured lights (4) white, green and blue, which identify the possible parking zones in which the relevant motor vehicle is located and a barcode identifying the device (10).The front of the PJP device (1) facing the interior of the vehicle (FIG. 1) consists of an alphanumeric keyboard (5), a digital display (6) and six buttons, three of them corresponding to the various controlled parking zones (7) and the other three referring to the status of the device (off, state and pay) (8) concerning the possible parking payment situations. Lastly it has a slot (9) for the credit or debit card reader and a socket for charging (11) shown in FIG. 3.

The MFL device (2) is a transmitter/receiver of any type of waves (preferably, RF), and is equipped with a signals transponder, a computer, a printer, a coin-box unit, a slot and a display to provide appropriate indications concerning its eventual manual use. It will also be equipped with a second transmitter/receiver of wireless frequencies to emit or receive information via GPRS, or similar.

Below follows an explanation of the functioning of the parking management system that employs the two devices PJP (1) and MFL (2) described above:

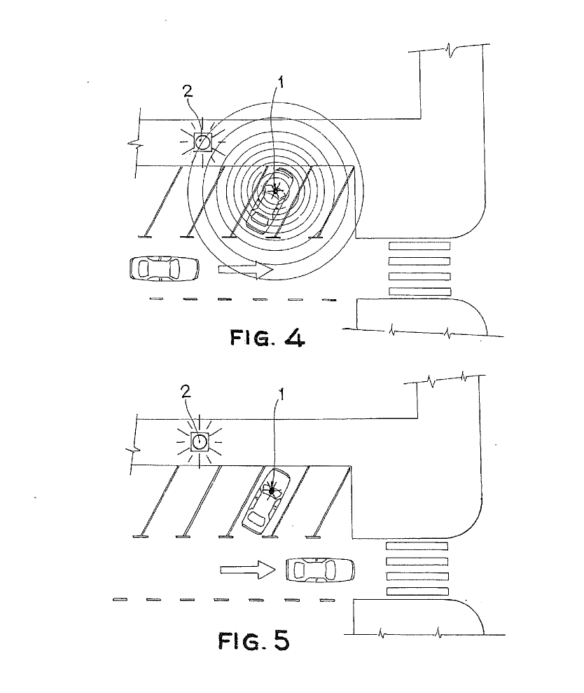

When the driver of the vehicle parks his car in a given parking-place he/she connects the PJP device (1) by pressing zone key (7) regarding the zone where the driver has parked the vehicle. At that moment the zone light (4) glows and the PJP device (1) emits a signal until it detects the nearest MFL device (2) according to the zone previously selected, as shown in FIG. 4.

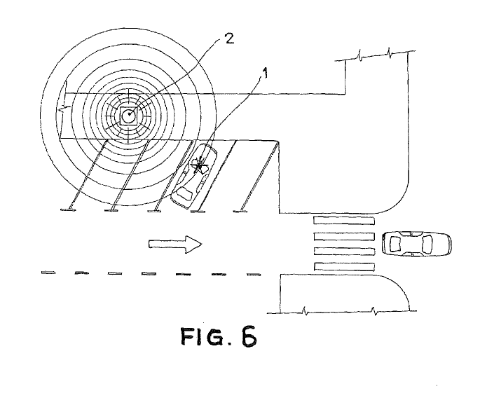

Once the MFL device (2) detects the signal of the PJP (1), as shown in FIG. 5, the MFL device (2) returns the signal to the PJP device (1) activating it (FIG. 6), a moment upon which the authorization light glows (3) and the process of debiting the payment card introduced in the (9) slot of the PJP device (1) begins.

At the precise time that the driver wishes to leave the car park, he/she should disconnect the PJP device (1) by pressing the OFF button on the State Keys (8), causing the PJP device (1) to issue a signal until it again detects the MFL device (2) which will return the signal to the PJP device (1) deactivating it and therefore turning off the “presence light” (3) and the corresponding area light (4). Once this has been done, the vehicle leaves its parking place with parking management deactivated; the MFL device (2) ceases to invoice and stores the data.

1-4. (canceled)

5. A parking management system comprising a first communication device and a second communication device, wherein the first communication device is configured to facilitate payment for a service, and the second communication device is configured to enable the service upon receiving payment information for the service.

6. The parking management system of claim 5, wherein the first communication device is mobile and the second communication device is stationary.

7. The parking management system of claim 5, wherein the payment is at least one of charge to a bank account and a charge to a payment card.

8. The parking management system of claim 5, wherein a status of the service is indicated on the first communication device.

9. The parking management system of claim 8, wherein the status of the service is designated by one of three colors, wherein a first color indicates an authorized service, a second color indicates a warning regarding the service, and a third color indicates an expired service.

10. The parking management system of claim 5, wherein the first communication device comprises at least one of authorization lights configured to indicate the status of service, zone lights configured to indicate a type of parking area, an alphanumeric keyboard, a digital display, zone keys for indicating the type of parking area, state keys for powering the first communication device, and a card reader slot to facilitate the payment.

11. The parking management system of claim 5, wherein the second communication device comprises at least one of a computer, a printer, a coin-box unit, a slot and a display to provide indications relating to manual use of the second communication device.

12. The parking management system of claim 5, wherein the first and the second communication devices are equipped with a transmitter/receiver of wireless frequencies.

13. The parking management system of claim 5, wherein the first communication device and the second communication communicate via a wireless protocol.

14. A method of managing parking comprising:
a. emitting a first signal by a first communication device;
b. enabling a service by a second communication device;
c. emitting a second signal by the first communication device; and
d. disabling the service by the second communication device.

15. The method of claim 14, wherein the enabling a service comprises allowing entrance into a parking garage or lot.

16. The method of claim 14, wherein the disabling the service comprises allowing exit from a parking garage or lot.

17. The method of claim 14, further comprising charging a bank account or a payment card for the service upon disabling the service.

18. A method of managing parking comprising:
a. requesting a service from a first communication device;
b. approving the request by a second communication device, thereby authorizing the beginning of a billing and indicating a status of the service on the first communication device;
c. ending the service from the first communication device; and
d. authorizing the end of the billing by the second communication device, thereby changing the status on the first communication device.

19. The method of claim 18, wherein the requesting comprises providing service details and payment information.

20. The method of claim 19, wherein the payment information is provided by introducing a payment card in a slot within the first communication device.

21. The method of claim 18, further comprising changing the status on the first communication device when the scope of the service nears an end.

22. The method of claim 18, further comprising changing the status on the first communication device when the scope of the service is exceeded.

23. The method of claim 22, further comprising requesting continued service from the first communication device.

24. The method of claim 18, further comprising recording information regarding the service on the second communication device.
